(19) United States
(12) Patent Application Publication
(10) Pub. No.: US 2020/0185919 A1
(43) Pub. Date: Jun. 11, 2020

(54) CONTROL FOR RESOURCE DISTRIBUTION NETWORK

(71) Applicant: BOISE STATE UNIVERSITY, Boise, ID (US)

(72) Inventors: John Gardner, Boise, ID (US); Ryan Schwartz, Boise, ID (US); Jason Kuwada, Boise, ID (US)

(21) Appl. No.: 16/709,512

(22) Filed: Dec. 10, 2019

Related U.S. Application Data
(60) Provisional application No. 62/778,056, filed on Dec. 11, 2018.

(51) Int. Cl. H02J 3/08; H02J 3/00; F24F 11/46

(52) U.S. Cl. CPC H02J 3/08; F24F 11/46; H02J 3/003; H02J 3/004

(57) ABSTRACT

A system may include a resource distribution network and multiple control devices coupled to the resource distribution network. Each of the control devices may be configured to control a state of consumption of a resource from the resource distribution network. Each of the control devices may be further configured to receive data from a set of neighboring control devices, where the data indicates respective states of consumption of the resource associated with each of the neighboring control devices, determine an average state of consumption associated with the set of neighboring control devices based on the data, and calculate at least one threshold value based on the average state of consumption associated with the set of neighboring control devices. Controlling the state of consumption of the resource may be based on a comparison of the measured value to the at least one threshold value.

### CROSS-REFERENCE TO RELATED APPLICATIONS

This application claims priority to and the benefit of U.S. Provisional Patent Application No. 62/778,056, filed on Dec. 11, 2018, and entitled “De-Centralized Control and Resilience for Distributed Energy Resources,” the contents of which are hereby incorporated by reference herein in their entirety.

### FIELD OF THE DISCLOSURE

This disclosure is generally related to the field of control for resource distribution networks and, in particular, to de-centralized control systems and methods for controlling resource distribution among multiple consumption systems such as multiple thermostats, battery chargers, data network endpoint devices, or other types of control devices.

### BACKGROUND

In response to continued and increasing climate change, carbon free energy systems and efficient power grids are becoming more desirable. Demand response (DR), is one approach to increasing grid flexibility by allowing a grid operator to control when or how electricity is consumed by certain customers. DR is well-proven, yet its deployment has been limited to programs that shed loads during periods of very high demand when additional generating capacity is scarce and, therefore, expensive.

Much of DR activity focuses on thermostatically controlled loads (TCLs) such as those systems used for space heating and cooling, domestic hot water or refrigeration and food storage. Systems that use electricity in this manner are normally designed to maintain temperature, not at a single constant set point, but within a range of temperatures, known as the thermostat deadband. A possible negative side effect of DR programs includes the potential synchronization of loads causing even larger peaks and unmanageable swings in the grid demand after a DR event is released. Similar shortcomings may exist in other applications as well. For example, battery charging and discharging may become synchronized due to consumer behaviors and natural synchronous patterns. Battery charger loads may be synchronized in response to daytime solar cycles when solar power is used as a significant source of power within a distribution grid.

Due to synchronization, peak load experienced after a DR event may, in some cases, exceed the size of the peak avoided by the DR itself. Further, depending on the heterogeneity of the load, the aggregate load could continue to oscillate through large variations over several hours, resulting in significant power losses. Some proposed solutions include time staggering loads in cases where synchronization is a risk, priority stack loads, and altering thermostat or charger set points in the aggregate to reduce synchronization problems. However, these processes may not take into consideration the needs of individual loads and may be computationally intensive and expensive to implement and maintain.

### SUMMARY

Disclosed herein are systems that may rely on a limited amount of highly localized peer-to-peer communication among a population of control devices to address the problem of synchronization. The advantages of the proposed method are that it reduces the computational load and communication load on both the individual control devices and on the distribution network operator.

In an embodiment, a method includes receiving, at a control device coupled to a resource distribution network, data from a set of neighboring control devices coupled to the resource distribution network, where the control device is configured to control a state of consumption of a resource from the resource distribution network, and where the data indicates respective states of consumption of the resource associated with each of the neighboring control devices. The method further includes determining an average state of consumption associated with the set of neighboring control devices based on the data. The method also includes calculating at least one threshold value based on the average state of consumption associated with the set of neighboring control devices. The method includes controlling the state of consumption of the resource based on a comparison of a measured value related to the consumption of the resource to the at least one threshold value.

In some embodiments, the control device includes a thermostat, the resource distribution network includes an electrical power distribution network, the set of neighboring control devices includes a set of neighboring thermostats, the state of consumption includes an on-off-state of the thermostat, the resource includes electrical power, the measured value includes a measured temperature value, and the respective states of consumption include respective on-off-states of associated with the set of neighboring thermostats. In some embodiments, the average state of consumption includes a ratio of neighboring thermostats in an on-state to a total number of thermostats in the set of neighboring thermostats. In some embodiments, calculating the at least one threshold value includes calculating a temperature deadband relative to a predetermined reference temperature deadband. In some embodiments, calculating the temperature deadband includes calculating a lower temperature limit of the temperature deadband by shifting a lower temperature limit of the predetermined reference temperature deadband based on the average state of consumption. In some embodiments, calculating the temperature deadband includes calculating a lower temperature limit and an upper temperature limit of the temperature deadband by shifting a lower temperature limit and an upper temperature limit of the predetermined reference temperature deadband based on the average state of consumption.

In some embodiments, the control device includes a battery charger, the resource distribution network includes an electrical power distribution network, the set of neighboring control devices includes a set of neighboring battery chargers, the resource includes electrical power, and the measured value includes a measured battery charge. In some embodiments, the state of consumption includes an on-off-state of the battery charger, and the respective states of consumption include respective on-off-states of associated with the set of neighboring battery chargers. In some embodiments, the state of consumption includes an electrical power consumption level of the battery charger, and the respective states of consumption include respective electrical power consumption levels associated with the set of neighboring battery chargers.

In some embodiments, the control device includes a data network endpoint device, the resource distribution network includes a data network, the set of neighboring control devices includes a set of neighboring data network endpoint devices, the state of consumption includes a data transfer rate of the data network endpoint device, the resource includes network data, the measured value includes a measured data transfer value, and the respective states of consumption include respective data transfer rates associated with the set of neighboring thermostats.

In some embodiments, the data is received directly from the set of neighboring control devices using a peer-to-peer communication protocol. In some embodiments, the data is received from the set of neighboring control devices via a central server. In some embodiments, the method includes before controlling the state of consumption of the resource based on a comparison of the measured value to the at least one threshold, receiving a demand response instruction, and controlling the state of consumption based on the demand response instruction.

In an embodiment, a system includes a resource distribution network and multiple control devices coupled to the resource distribution network, where each of the control device is configured to control a state of consumption of a resource from the resource distribution network, receive data from a set of neighboring control devices, where the data indicates respective states of consumption of the resource associated with each of the neighboring control devices, determine an average state of consumption associated with the set of neighboring control devices based on the data, and calculate at least one threshold value based on the average state of consumption associated with the set of neighboring control devices, where controlling the state of consumption of the resource is based on a comparison of the measured value to the at least one threshold value.

In some embodiments, the multiple control devices include thermostats, the resource distribution network includes an electrical power distribution network, the state of consumption includes an on-off-state, the resource includes electrical power, the measured value includes a measured temperature value, and the respective states of consumption include respective on-off-states of associated with the set of neighboring thermostats.

In some embodiments, the multiple control device include thermostats, the resource distribution network includes an electrical power distribution network, the state of consumption includes a transitional state between on-off-states, the resource includes electrical power, the measured value includes a measured temperature value, and the respective states of consumption include respective on-off-states of associated with the set of neighboring thermostats.

In some embodiments, the multiple control devices include battery chargers, the resource distribution network includes an electrical power distribution network, the set of neighboring control devices includes a set of neighboring battery chargers, the resource includes electrical power, and the measured value includes a measured battery charge.

In some embodiments, the multiple control devices include data network endpoint devices, the resource distribution network includes a data network, the set of neighboring control devices includes a set of neighboring data network endpoint devices, the state of consumption includes a data transmission bandwidth consumption of the data network endpoint device, the resource includes data transmission, the measured value includes a measured data upload-download value, and the respective states of consumption include respective data transmission bandwidth consumption associated with the set of neighboring thermostats.

In an embodiment, a control device includes a processor and memory storing instructions that, when executed by the processor, cause the control device to control a state of consumption of a resource from the resource distribution network, receive data from a set of neighboring control devices, where the data indicates respective states of consumption of the resource associated with each of the neighboring control devices, determine an average state of consumption associated with the set of neighboring control devices based on the data, and calculate at least one threshold value based on the average state of consumption associated with the set of neighboring control devices, where controlling the state of consumption of the resource is based on a comparison of the measured value to the at least one threshold value.

In some embodiments, the control device includes a thermostat, the resource distribution network includes an electrical power distribution network, the set of neighboring control devices includes a set of neighboring thermostats, the state of consumption includes an on-off-state of the thermostat, the resource includes electrical power, the measured value includes a measured temperature value, and the respective states of consumption include respective on-off-states of associated with the set of neighboring thermostats. In some embodiments, the average state of consumption includes a ratio of neighboring thermostats in an on-state to a total number of thermostats in the set of neighboring thermostats.

### BRIEF DESCRIPTION OF THE DRAWINGS

FIG. 1 depicts an embodiment of a system for controlling resource distribution.

FIG. 2 depicts an embodiment of a system for controlling resource distribution.

FIG. 3 depicts an embodiment of a system for controlling resource distribution at a thermostat.

FIG. 4 depicts an embodiment of a system for controlling resource distribution at a thermostat.

FIG. 5 depicts an embodiment of a system for controlling resource distribution at a thermostat.

FIG. 6 depicts an embodiment of a system for controlling resource distribution at a battery charger.

FIG. 7 depicts an embodiment of a system for controlling resource distribution at a battery charger.

FIG. 8 depicts an embodiment of a system for controlling resource distribution at a data network endpoint device.

FIG. 9A is a graph depicting demand during a demand response event for a homogeneous population.

FIG. 9B is a graph depicting demand during a demand response event for a heterogeneous population.

FIG. 10A is a graph depicting demand where an m criteria is implemented upon completion of the demand response event for a homogenous population.

FIG. 10B is a graph depicting demand where an m criteria is implemented upon completion of the demand response event for a heterogeneous population.

FIG. 11A is a graph depicting demand where an m criteria is applied to a single side of a deadband for a homogenous population.

FIG. 11B is a graph depicting demand where an m criteria is applied to a single side of a deadband for a heterogenous population.

FIG. 12A is a graph depicting demand where an m criteria is applied without a demand response event for a homogenous population.

FIG. 12B is a graph depicting demand where an m criteria is applied without a demand response event for a heterogenous population.

FIG. 13 depicts an embodiment of a method for controlling resource distribution.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the scope of the disclosure.

### DETAILED DESCRIPTION

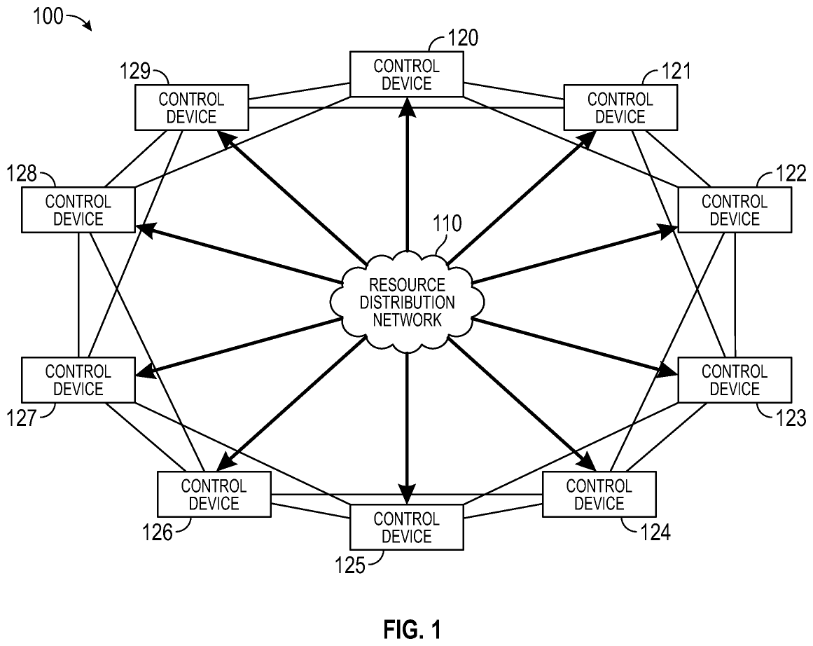

Referring to FIG. 1, an embodiment of a system 100 for controlling resource distribution is depicted. The system 100 may include a resource distribution network 110. As an example, the resource distribution network 110 may include a power distribution network for distributing electrical power among electrical power consumer devices or premises. As another example, the resource distribution network 110 may include a data network and may distribute or enable data transfer capabilities among network endpoint devices. Additional examples may exist. The systems and methods disclosed herein are contemplated to be usable with any type of resource distribution network 110 for which it may be desirable to apportion a resource among multiple consumer devices.

The system 100 may further include multiple control devices 120-129 coupled to the resource distribution network 110. Each of the control devices 120-129 may be configured to control a state of consumption of a resource from the resource distribution network 110. Examples of the control devices 120-129 may include thermostat devices, battery charger devices, network endpoint devices, or any other device configured to control a level of consumption or a state of consumption of a resource from the resource distribution network 110.

Each of the control devices 120-129 may be networked with a set of neighboring control devices, as depicted by the lines between the control devices 120-129 in FIG. 1. For example, the control device 120 may be networked with the control devices 121, 122, 128, 129. The control device 121 may be networked with the control devices 120, 122, 123, 129. This pattern may continue such that each of the control devices 120-129 is networked to a set of neighboring control devices. The set of neighboring control devices may include devices that are geographically nearest to each other or topographically nearest to each other within the resource distribution network 110.

Each of the control devices 120-129 may be configured to receive data from their respective neighboring control devices. The data received by each of the control devices 120-129 may indicate respective states of consumption, which may include levels of consumption, of the resource associated with each of the neighboring control devices. Based on the data, each of the control devices 120-129 may determine an average state of consumption associated with the set of neighboring control devices and calculate at least one threshold value based on the average state of consumption associated with the set of neighboring control devices.

For example, in the case where the multiple control devices 120-129 include thermostats, the data may indicate respective on-off-states of neighboring thermostats and each thermostat may calculate an average value representing a ratio of neighboring thermostats in an on-state to a total number of thermostats in the set of neighboring thermostats. Based on the average value, each thermostat may calculate a deadband for controlling its own on-off-state. As another example, the multiple control devices 120-129 may include battery chargers and each battery charger may calculate an average power consumption of neighboring battery chargers. Based on the average power consumption, each battery charger may calculate a threshold charge level for controlling its own charging state or charging level. As another example, the multiple control devices 120-129 may include network endpoint devices and each may calculate an average data transfer rate of neighboring network endpoint devices. Based on the average data transfer rate, each network endpoint device may calculate a threshold level for controlling its own data transfer rate.

The lines depicted between the control devices 120-129 may represent a network connection between the control devices 120-129 and their neighbors. The network may include a peer-to-peer network with the control devices 120-129 being connected to each other using peer-to-peer protocols. In some embodiments, the network may include server-client connections where each of the control devices 120-129 are networked together through one or more central servers. Other configurations are possible.

While FIG. 1 depicts only 10 control devices 120-129, more or fewer than 10 may be included in the system 100. In the example where the resource distribution network is an electrical power distribution network, the system 100 may include thousands of control devices. Likewise, while FIG. 1 depicts each of the control devices 120-129 as being networked to a set four neighboring control devices, each set of neighboring control devices may include more or fewer than four. Further, each of the control devices 120-129 may be networked with a different number of neighboring control devices.

A benefit of the system 100 is that by each control device 120-129 determining its own state of consumption based on neighboring control devices, the system 100 may avoid synchronization problems that may cause stress on the resource distribution network 110. Further, the system 100 may be less complex as compared to systems that utilize a centralized controller to control each control device. Other benefits may exist.

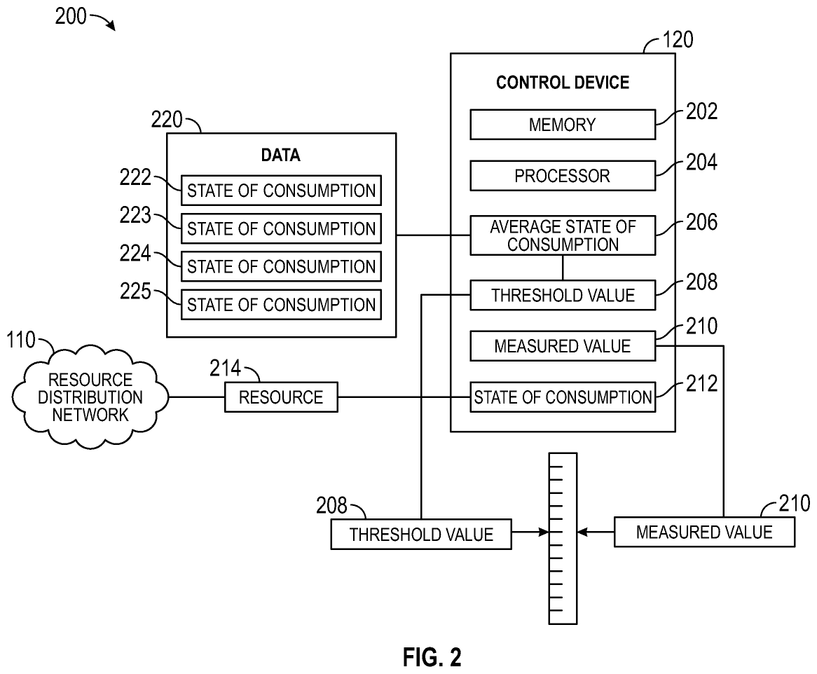

Referring to FIG. 2, an embodiment of a system 200 for controlling resource distribution is depicted. FIG. 2 may provide a description of the systems and methods associated with the system 100 of FIG. 1 from the perspective of a single control device, such as the control device 120.

The control device 120 may include a memory 202 and a processor 204. The processor 102 may include a central processing unit (CPU), a graphical processing unit (GPU), a digital signal processor (DSP), a peripheral interface controller (PIC), or another type of microprocessor. It may be implemented as an integrated circuit, a field programmable gate array (FPGA), an application specific integrated circuit (ASIC), a combination of logic gate circuitry, other types of digital or analog electrical design components, or the like, or combinations thereof. In some examples, the processor 204 may be distributed across multiple processing elements, relying on distributive processing operations.

The memory 202 may include random-access memory (RAM), read-only memory (ROM), magnetic disk memory, optical disk memory, flash memory, another type of memory capable of storing data and processor instructions, or the like, or combinations thereof. In some examples, the memory 202, or portions thereof, may be located externally or remotely from the rest of the system 200. The memory 202 may store instructions that, when executed by the processor 204, cause the processor 204 perform operations associated with the control device 120 as described herein.

The control device 120 may control a state of consumption 212 of a resource 214 from the resource distribution network 110. In order to control the state of consumption 212, the control device 120 may receive data 220 from a set of neighboring control devices. The data 220 may indicate respective states of consumption 222-225 of the resource 214 associated with each of the neighboring control devices. Based on the data 220, the control device 120 may determine an average state of consumption 206 associated with the set of neighboring control devices. In some cases, the average state of consumption 206 may include a number of neighboring control devices that are in an on-state to the total number of neighboring control devices. In some cases, the average state of consumption 206 may include a mean average, median average, or other type of mathematical average of consumption rates of neighboring control devices.

Based on the average state of consumption 206, the control device 120 may calculate at least one threshold value 208. The threshold value 208 may be determined in multiple different ways. In some cases, the threshold value 208 may be determined by shifting a reference value while using the average state of consumption 206 as a scalar to determine the magnitude of shifting. In some cases, the threshold value 208 may be part of a deadband where the deadband is calculated by using the average state of consumption to shift an upper bound or lower bound of a reference deadband.

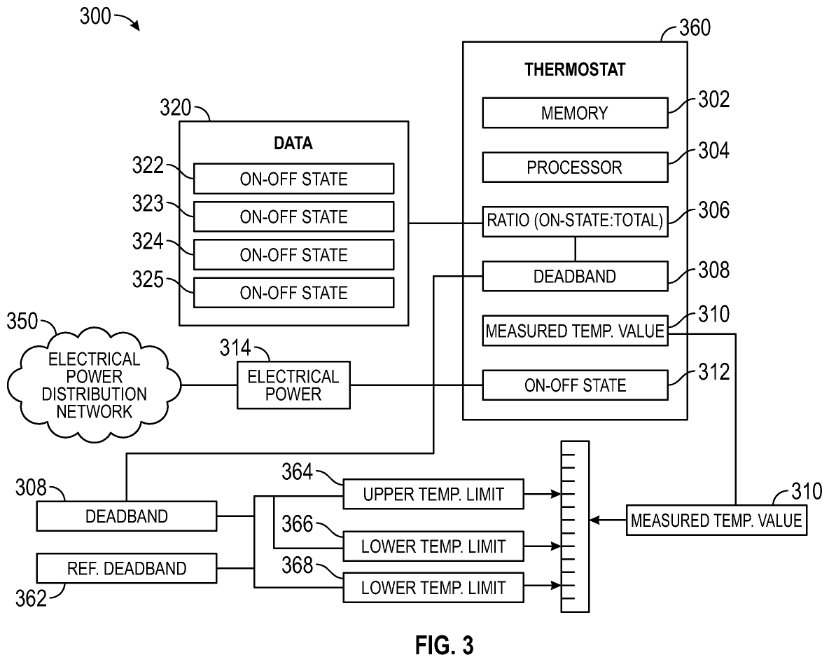

The control device 120 may control the state of consumption 212 of the resource 214 based on the threshold value 208. For example, the threshold value 208 may be compared to a measured value 210 to change the state of consumption 212 from an off-state to an on-state. As another example, the threshold value 208 may be compared to the measured value 210 to determine whether to increase or decrease a consumption rate. FIGS. 3-8 describe specific examples of the system 200. Other examples may exist.

A benefit of the system 200 is that a load on the resource distribution network 110 may be smoothed and the control device 120 can avoid contributing to large spikes in resource consumption by controlling its own state of consumption 212 based on the average state of consumption 206 of other neighboring control devices. The control device 120 may also receive the data 220 in a decentralized way, without relying on additional infrastructure such as one or more central servers. Thus, the system 200 may be less complex as compared to systems the rely on other means for staggering resource consumption from a distribution network. Other advantages may exist.

FIG. 3 depicts an embodiment of a system 300 for controlling resource distribution at a thermostat 360. In the embodiment of FIG. 3, the resource distribution network 110 of FIGS. 1 and 2 may be an electrical power distribution network 350, the resource 214 of FIG. 2 may be electrical power 314, and the control device 120 of FIGS. 1 and 2 may be the thermostat 360. As with the control device 120, the thermostat 360 may include a memory 302 and a processor 304, where the memory 302 may store instructions that, when executed by the processor 304, cause the processor 304 perform operations associated with the thermostat 360 as described herein.

The thermostat 360 may control an on-off-state 312 that directs whether the electrical power 314 is consumed from the electrical power distribution network 350. In order to control the on-off-state 312, the thermostat 360 may receive data 320 from a set of neighboring thermostats. The data 320 may indicate respective on-off-states 322-325 associated with each of the neighboring thermostats. Based on the data 320, the thermostat 360 may determine a ratio 306 of neighboring thermostats in an on-state to the total number of neighboring thermostats. Based on the ratio 306, the thermostat 360 may calculate a deadband 308. The deadband 308 may be used in conjunction with a measured temperature value 310 for determining an on-off-state 312 of the thermostat 360.

The deadband 308 may be calculated based on a reference deadband 362 that may be set by a user at the thermostat 360. For example, the reference deadband 362 may include an upper temperature limit 364 and a lower temperature limit 368. The calculated deadband 308 may have the same upper limit 364 as the reference deadband 362. However, the calculated deadband 308 may have a lower temperature limit 366 that is adjusted to be positioned between the upper temperature limit 364 and the lower temperature limit 368 of the reference deadband 362. The exact position of the lower limit 366 of the calculated deadband 308 may be determined based on the ratio 306. For example, in some cases the lower temperature limit 366 may be adjusted relative to the reference deadband 362 in proportion to the ratio 306. In some cases, the effect of the ratio 306 in the calculation may be increased or decreased based on a scaling factor.

Electrical power distribution networks, in general, may be sensitive to synchronized loads, particularly after DR events. A benefit of the system 300 is that a load on the electrical power distribution network 350 may be smoothed and the thermostat 360 can avoid contributing to a large spike in electrical power consumption. This may be particularly beneficial in the case of air conditioner or other refrigeration systems. Other advantages may exist.

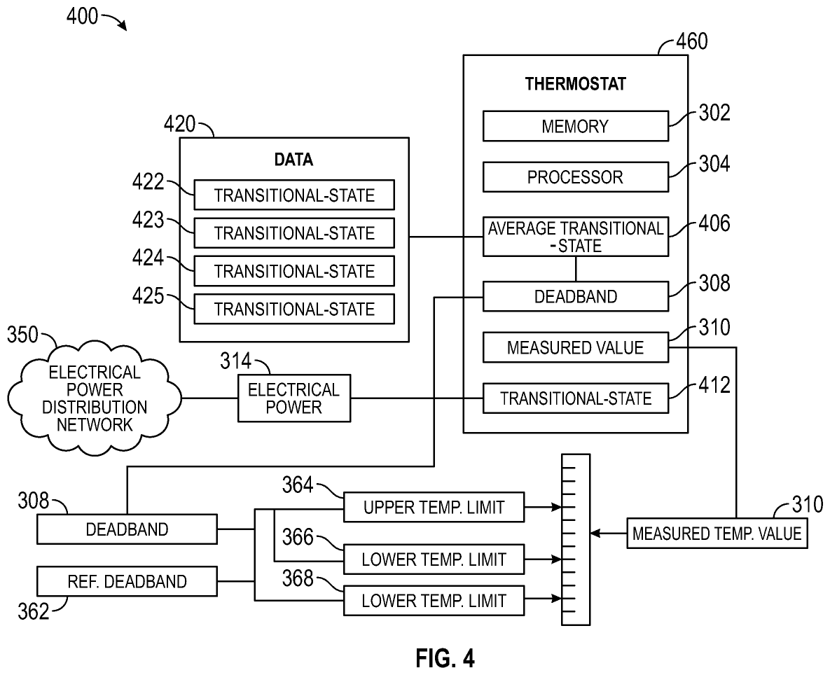

FIG. 4 depicts an embodiment of a system 400 for controlling resource distribution at a thermostat 460. Rather than having an on-off-state, as with the thermostat 360, the thermostat 460 may be in a transitional-state 412 somewhere between on and off, such as low-power, medium-power, or high power. In some embodiments, the transitional-state 412 correspond to a power consumption level along a continuous scale.

The thermostat 460 may receive data 420 indicating respective transitional-states 422-425 associated with each of the neighboring thermostats. Based on the data 420, the thermostat 460 may determine an average transitional-state 406 of the neighboring thermostats. Based on the average transitional state 406, the thermostat 460 may calculate the deadband 308. The deadband 308 may then be used in conjunction with a measured temperature value 310 for determining an on-off-state 312 of the thermostat 460 as described with reference to the preceding FIGS.

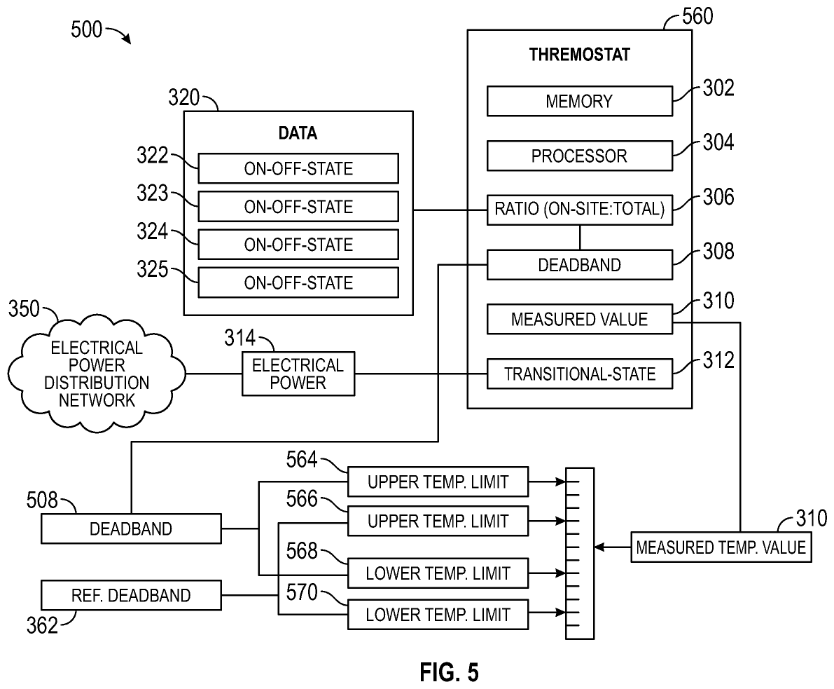

FIG. 5 depicts an embodiment of a system 500 for controlling resource distribution at a thermostat 560. Rather than shifting only the lower bound of the reference deadband 362 as with the thermostats 360, 460, the thermostat 560 may shift the entire reference deadband 362. For example, the reference deadband 362 may have an upper bound 566 and a lower bound 570. Both the upper bound 566 and the lower bound 570 of the reference deadband 362 may be shifted in proportion to, or otherwise based on, the ratio 306 to determine an upper bound 564 and a lower bound 568 of the calculated deadband 508.

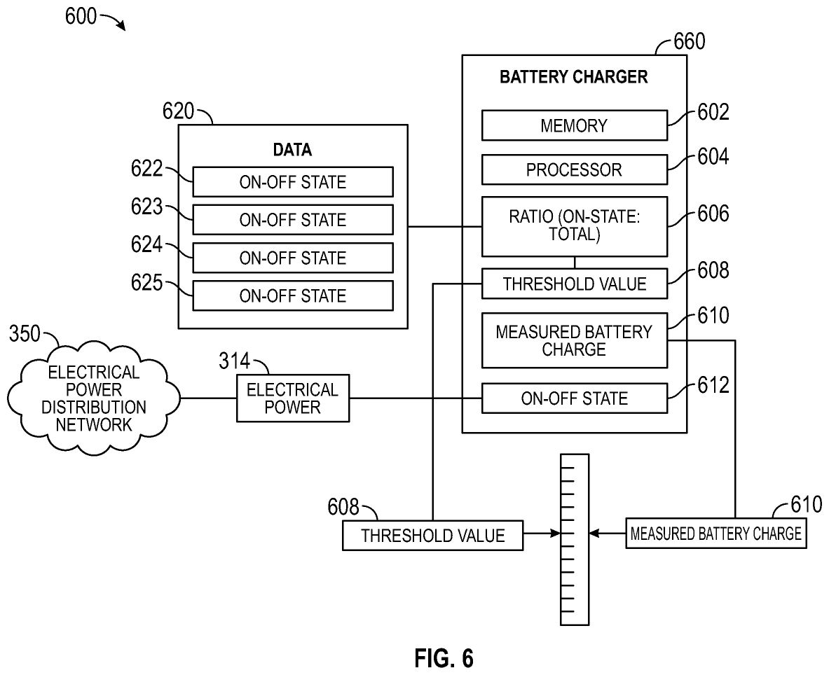

FIG. 6 depicts an embodiment of a system 600 for controlling resource distribution at a battery charger 660. In the embodiment of FIG. 6, the control device 120 of FIGS. 1 and 2 may be the battery charger 660. As with the control device 120, the battery charger 660 may include a memory 602 and a processor 604, where the memory 602 may store instructions that, when executed by the processor 604, cause the processor 604 perform operations associated with the battery charger 660 as described herein.

The battery charger 660 may control an on-off-state 612 that directs whether the electrical power 314 is consumed from the electrical power distribution network 350. In other words, the battery charger 660 may determine whether a battery is charging or not. In order to control the on-off-state 612, the battery charger 660 may receive data 620 from a set of neighboring battery chargers. The data 620 may indicate respective on-off-states 622-625 associated with each of the neighboring battery chargers. Based on the data 620, the battery charger 660 may determine an average state of consumption 606 of neighboring battery chargers. Based on the average state of consumption 606, the battery charger 660 may calculate a threshold value 608. The threshold value 608 may correspond to a battery charge level at which the on-off-state 612 changes from an off-state to an on-state. The threshold 608 may be used in conjunction with a measured battery charge 610 for determining an on-off-state 612 of the battery charger 660.

Battery chargers coupled to an electrical power distribution network may be susceptible to synchronization due to DR events or even time of day events, such as customers plugging in electric cars after work. A benefit of the system 600 is that a load on the electrical power distribution network 350 may be smoothed and the battery charger 660 can avoid contributing to large spikes in electrical power consumption. Other advantages may exist.

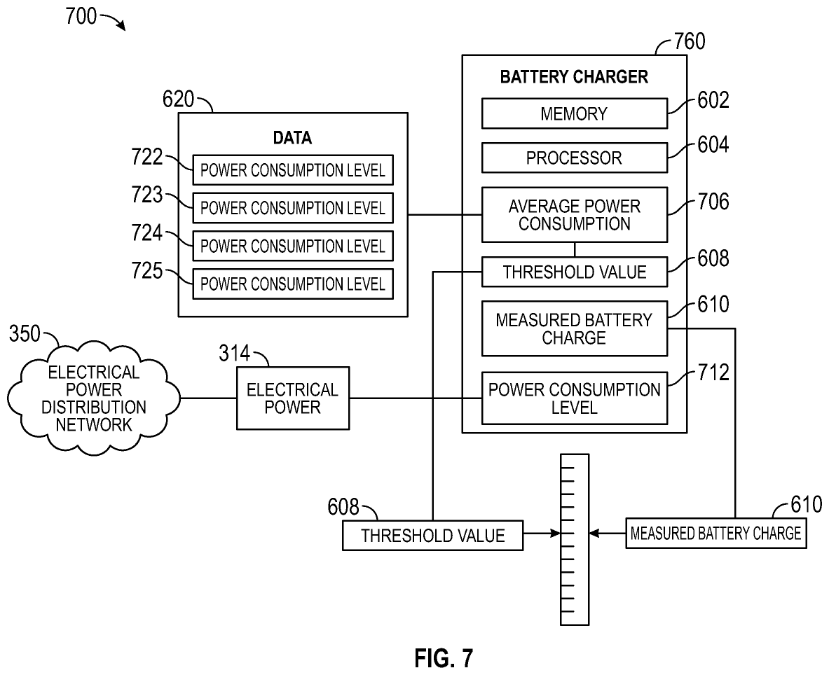

FIG. 7 depicts an embodiment of a system 700 for controlling resource distribution at a battery charger 760. Rather than having an on-off-state, as with the battery charger 660, the battery charger 760 may have a power consumption level 712 along a continuous scale.

The battery charger 760 may receive data 620 indicating respective power consumption levels 722-725 associated with each of the neighboring battery chargers. Based on the data 620, the battery charger 760 may determine an average power consumption level 706 of the neighboring battery chargers. Based on the average power consumption level 706, the battery charger 760 may calculate the threshold value 608. The threshold value 608 may then be used in conjunction with a measured battery charge 610 for determining a power consumption level 712 of the battery charger 760 as described with reference to the preceding FIG. 6.

The system 700 may be implemented in systems that charge a battery (such as an electric car battery or a backup electrical system) with the electrical power 314 received from the electrical power distribution network 350. However, in a particular application, the system 700 may also be implemented in a smart inverter system (such as an inverter for a consumer solar energy system) where a battery may be charged using another power source and a determination is made whether to supply excess power generated to the electrical power distribution network 350. In that case, the power consumption level 712 may be negative, representing a negative load that adds electrical power 314 to the electrical power distribution network 350. The battery charger 760 may receive the data 620 from other inverter systems to determine a threshold value 608 that may be indicative of whether to supply the electrical energy 314 to the energy the electrical power distribution network 350. In that way, multiple inverter systems may work in a concerted and decentralized way to supply the electrical power 314 to the electrical power distribution network 350.

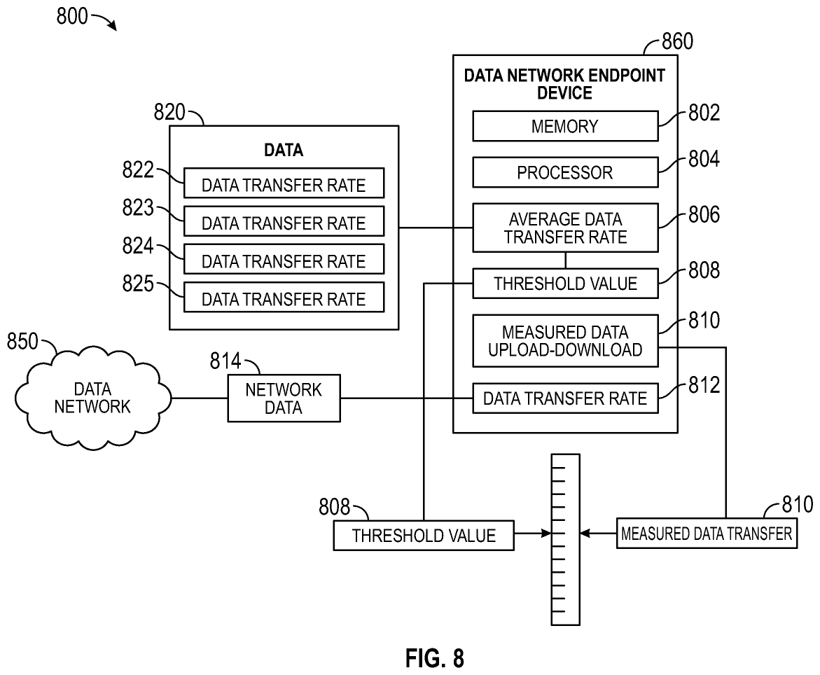

FIG. 8 depicts an embodiment of a system 800 for controlling resource distribution at a data network endpoint device 860. In the embodiment of FIG. 8, the resource distribution network 110 of FIGS. 1 and 2 may be a data network 850, the resource 214 of FIG. 2 may be network data 814, and the control device 120 of FIGS. 1 and 2 may be the data network endpoint device 860. The data network endpoint device 860 may include a personal computer, or other network connected device. The network data 814 may include internet data, media streaming data, or other types of network data. As with the control device 120, the data network endpoint device 860 may include a memory 802 and a processor 804, where the memory 802 may store instructions that, when executed by the processor 804, cause the processor 804 perform operations associated with the data network endpoint device 360 as described herein.

The data network endpoint device 860 may control data transfer rate 812 that directs whether, and at what level, the network data 814 is consumed from the data network 850. In order to control the data transfer rate 812, the data network endpoint device 860 may receive data 820 from a set of neighboring data network endpoint devices. The data 820 may indicate respective data transfer rates 822-825 associated with each of the neighboring data network endpoint devices. Based on the data 820, the data network endpoint device 860 may determine an average data transfer rate 806 associated with the neighboring data network endpoint devices. Based on the average data transfer rate 806, the data network endpoint device 860 may calculate a threshold value 808. The threshold value 808 may be used in conjunction with a measured data transfer value 810 for determining the data transfer rate 812. For example, the data transfer rate 812 may be decreased when the measured data transfer value 810 reaches the threshold value 808.

Data networks, in general, may be sensitive to synchronized loads and periods of high load. A benefit of the system 800 is that a load on the data network 850 may be smoothed and the data network endpoint device 860 can avoid contributing to a large spike in data consumption. This may be particularly beneficial in the case of video streaming service systems. Other advantages may exist.

While multiple embodiments have been described herein, below is an example of a specific implementation with respect to a thermostat.

### Thermostat Example

This thermostat example uses a 1R1C model of a home's thermal mass and effective thermal resistance of the envelope. This model has proven to be effective in understanding a large number of agents acting in the aggregate.

Under the 1R1C model, individual homes may interact with the environment (outside temperature) and can communicate with neighboring houses. In order to understand how the environment and the house interact, the heat transfer mechanics between them may be examined. The thermal dynamics of a house can be approximated as a first-order ordinary differential equation:

$$T ( t ) = \frac{1}{RC} ( {T}_{∞} ( t ) - T ( t ) + R ( {Q}_{I} - m ( t ) \overline{Q} ) )$$

Here, T and T_{∞} correspond to the internal and the ambient temperatures (° C.), respectively. The thermal capacitance, C (kWh/° C.), and thermal resistance, R (° C./kWh), are properties related to factors such as building insulation and materials. Q_{I} (kW) is the heat generated by internal loads, which is considered an external disturbance and hereafter neglected in the analysis. Q̅ (kW) is the nominal capacity of the AC system, that is, the rate at which it removes heat when in the ON state. The ON/OFF signal m(t) is controlled by the thermostat and the corresponding temperature limits:

$$m ( t ) = \{ \begin{matrix}0 , & if T ( t ) \leq {T}_{min} \\ 1 , & if T ( t ) \geq {T}_{max} \\ m ( {t}^{-} ) , & otherwise\end{matrix}$$

where Tₘᵢₙ and Tₘₐₓ are the lower and upper limits of the thermostat deadband, δ. The setpoint temperature, Tₛₚ, is related to these limits as follows:

$${T}_{m i n} = {T}_{sp} - \frac{δ}{2} , \\ {T}_{m ax} = {T}_{sp} + \frac{δ}{2}$$

Considering a population containing N TCLs, the total load can be expressed as:

$${P}_{TCL} ( t ) = {\sum }_{i = 1}^{N} \frac{1}{{η}_{i}} {\overline{Q}}_{i} {m}_{i} ( t )$$

where ηᵢ is the coefficient of performance (COP) of the ith load.

In this example, a small amount of information may be shared between thermostats that are in close proximity. In particular, each home may be aware of the on/off state of the compressors in the 4 nearest homes. The selection of the connections may be defined by the layout of the neighborhood (e.g. the next door neighbors, the house across the street and over the fence in the backyard) or they may be defined by the topology of the electric distribution system.

The logistics of information sharing are not covered in this study, but it is clear that a large number of options are available covering a spectrum of technologies from internet-based server models where the connections can be implemented and programmed centrally, to local communication protocols such as Zigbee, Bluetooth and power-line carrier methods.

Graph theory may be used to understand the model of this network of connected houses. In graph theory the network (or graph) may be described as a set of nodes (the agents) and edges (links between agents). The degree, d, of a node describes the number of connections that node has to other nodes. These connections between agents can be directed or undirected. In a directed link, connection is established in one direction from one agent to another, similar to citations in a paper or a web page linking to another webpage. Other networks utilize undirected links, like the power grid where transmission line current can flow both directions.

The connections between residential thermostats in this model may be undirected because connected houses know the ON/OFF state of each other's AC units. Networks of connections may be represented as an adjacency matrix, A. For a network containing N nodes, the adjacency matrix has N rows and N columns containing elements that follow the rules:

$$\{ \begin{matrix}0 , & if nodes i and j are not connected to each other \\ 1 , & if nodes i and j are connected to each other\end{matrix}$$

For an undirected network the adjacency matrix is symmetric, Aij=Aji, and since a house is not connected to itself, the diagonal consists of zeros. The adjacency matrix can be used to find the degree of house i by summing either the column or the row corresponding to that house:

$${d}_{i} = {\sum }_{j = 1}^{N} {𝒜}_{ij} = {\sum }_{j = 1}^{N} {𝒜}_{ji}$$

Now consider a situation in which the state of the AC unit, m(t), for each house can be communicated from its thermostat to nearby connected thermostats. The variable \tilde{m}ᵢ is introduced to represent the average state of the thermostats communicating with agent i. The adjacency matrix representing connected agents can be used to easily calculate all of these values simultaneously:

$$\tilde{m} = \frac{1}{d} 𝒜 m$$

Consider a new non-dimensional temperature parameter, θᵢ, where the bottom of the deadband is θᵢ=0 and the top of the deadband is θᵢ=1.

$${θ}_{i} = \frac{{T}_{i} - {T}_{m i n , i}}{{T}_{m ax , i} - {T}_{m i n , i}} = \frac{{T}_{i} - ( {T}_{sp , i} - \frac{{δ}_{i}}{2} )}{{δ}_{i}}$$

Now typical thermostat behavior can be described in terms of this normalized parameter instead of individual house temperatures and deadbands:

$$m ( t ) = \{ \begin{matrix}0 , & if θ \leq 0 \\ 1 , & if θ \geq 1 \\ m ( {t}^{-} ) , & otherwise\end{matrix}$$

Here, a new addition to the thermostat model is proposed which uses the average state of the surrounding units, \tilde{m}, to inhibit operation based on the number of connected units that are operating.

$$m ( t ) = \{ \begin{matrix}0 , & if θ - k \tilde{m} \leq 0 \\ 1 , & if θ - k \tilde{m} \geq 1 \\ m ( {t}^{-} ) , & otherwise\end{matrix}$$

The addition of the average ON/OFF state of connected neighbors allows agents to reduce overall demand by causing an earlier entry to the OFF state if a larger number of neighbors turn ON. For example, consider a network with d=4, where two of a house's neighbors are ON, resulting in \tilde{m} of 0.5. Assuming k=1, this house will turn OFF as soon as θ=0.5, or halfway through the deadband, instead of the standard θ=0.

Individual AC unit state behavior may be modeled using a state chart. The state chart keeps track of what state the AC unit is in and transitions between states if certain thermostat criteria are met. The AC may have two states (ON, OFF). It should be noted that to prevent rapid cycling, AC unit compressors typically have a time relay installed that ensures the compressor remains off for a short amount of time (3-10 minutes), during which the unit ignores signals sent by the thermostat. Preliminary studies with and without this ‘locked’ state showed it has minimal effect on the results and is therefore not included in the model.

There are various network types for connecting agents within AnyLogic, such as random, distance based, ring lattice, and scale free. The ring lattice network may be used for this model in order to have an equal number of connections per agent. A ring lattice is also an approximation of a nearest neighbors network, where each house is connected to the specified number of closest agents.

An agent population of 100 houses connected in a ring lattice with d=4 may be used. This is a large enough number to produce meaningful results, but small enough for rapid simulation testing in AnyLogic. Each house may be randomly assigned parameters and the start state of ON or OFF is evenly split among them.

Both homogeneous and heterogeneous population of agents are modeled. Table 1 below depicts homogeneous house parameters. This is a good representation assuming the modeled population of houses is tract housing, sometimes referred to as cookie cutter neighborhoods, where all the houses are very similar in design.

TABLE 1
Population Parameter Values

| | | Standard Deviation |
|---|---|---|
| Parameter | Value | (Heterogeneous) |
| R, Thermal resistance | 2° C./kW | 0.1° C./kW |
| C, Thermal capacitance | 10 kWh/° C. | 0.5 kWh/° C. |
| P, Energy transfer rate | 14 kW | — |
| η, Load efficiency | 2.5 | 0.125 |
| Tₛₚ₀, Initial setpoint temperature | 20° C. | 1° C. |
| T_{∞}, Ambient temperature | 32° C. | |
| Δ, Thermostat deadband | 0.5° C. | 0.025° C. |

Many neighborhoods contain a mix of houses that vary in age, size, and building materials. To develop a model for these neighborhoods, a heterogeneous set of parameters must be used. This can be done by creating a statistical distribution around the homogeneous values, the standard deviations of which are shown in Table 1.

The energy transfer rate of a house's AC unit is sized depending upon the thermal dynamics of the house. The homogeneous population of houses' 14 kW is equivalent to a 4 ton unit (1 ton=3.5 kWth), which, for these parameters, means that the cooling rate is 0.8° 246 C/hr, or the temperature moves from the upper limit of the deadband to the lower limit in about 37.5 minutes. The necessary tonnage to achieve this cooling time for the heterogeneous population was calculated and then rounded up to the nearest half-ton to reflect sizes commercially available. The resulting range in unit sizes is 3.5-5 tons (12.25-17.5 kWth). Rounding up of the unit size results in slight over sizing, which means some houses will cooler faster than 37.5 minutes and therefore cycle more often than their homogeneous counterpart. The minimum cooling time for a heterogeneous house is 30.4 minutes.

For the purposes of this example a population of 100 homes was chosen, though various runs at numbers up to 10,000 show qualitatively similar results to what are presented here. Two different populations were investigated, one in which all the thermal parameters were identical, forming a homogeneous population as one might find in a highly uniform housing development. The other had the parameters distributed in a log-normal fashion around the homogeneous values. While a truly homogeneous population is unlikely, it forms a useful baseline in that it is recognized as a worst-case scenario regarding possible synchronization of load populations.

Hourly temperature data from the typical meteorological year (TMY) file for Boise, Id. for the days of July 21 and July 22 is used to represent a realistic summer temperature profile. Typically, DR events are scheduled during times of peak load. Focusing on the first day (July 21), a peak of 504 kW occurs at 5:31 PM for the homogeneous population. For the heterogeneous population, a peak of 447 kW occurs at 4:42 PM. To prevent these peak demand values, a DR event is initiated six minutes before each peak time and lasts fifteen minutes. During this time all of the compressors are forced OFF.

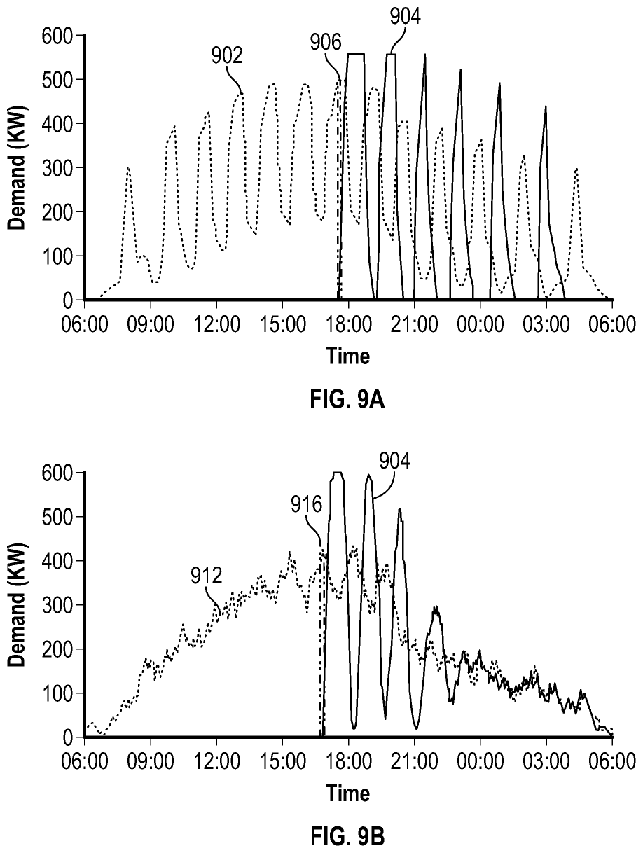

FIG. 9A depicts demand during a DR event for a homogeneous population and FIG. 9B depicts demand during a DR event for a heterogeneous population. The references 902, 912 depict a baseline demand profile. The references 904, 914 depicts demand after a DR event. The references 906, 916 depict energy saved during the DR event. As shown in FIGS. 9A and 9B, the DR event causes both populations to synchronize, resulting in a larger peak demands immediately following the DR event. The heterogeneous population DR event response has a damping effect due to the parameter spread and returns to baseline levels within approximately 7 hours of spiking. The load displayed in FIGS. 9A and 9B is only aggregate air conditioning load and is not representative of the overall demand the grid sees.

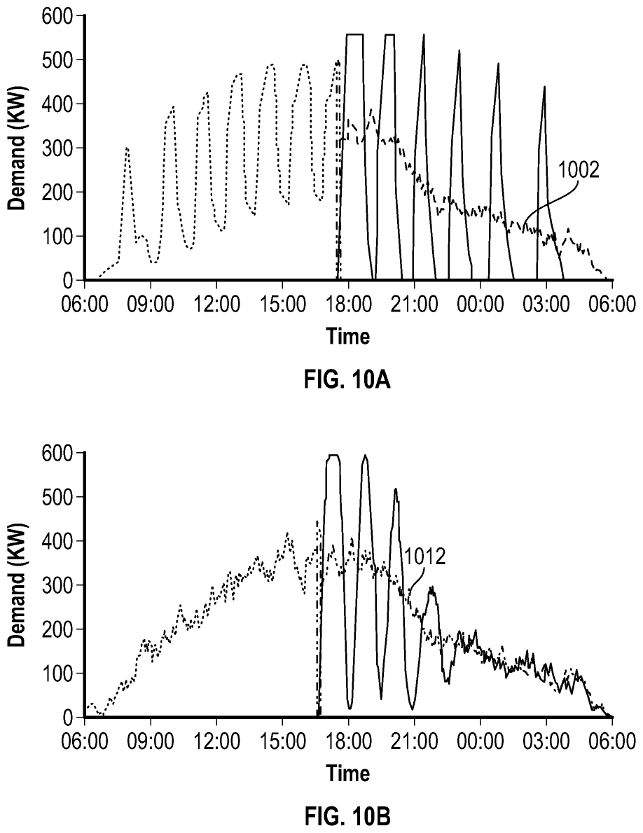

FIGS. 10A and 10B depict demand where an m criteria is implemented with a gain value of k=0.87 upon completion of the DR event for a homogenous and heterogeneous population, respectively. References 1002, 1012 depict the \tilde{m} criteria demand profile post DR event. As seen in FIGS. 10A and 10B, the emergent behavior that results from the \tilde{m} criteria greatly smoothes and reduces the demand following the DR event for both populations.

This is possible due to individual houses spending a considerable amount of time above their deadband in the hours immediately following the DR event. Over the course of the 24-hour time window, a home in the homogeneous population spends an average of 2.6 hours above the deadband, while a heterogeneous house spends an average of almost 3 hours above the deadband.

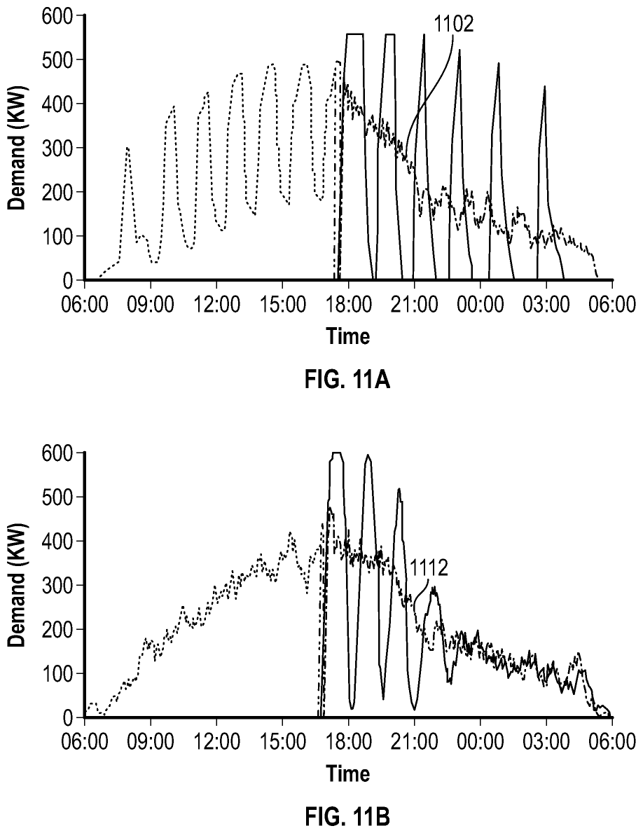

Referring to FIGS. 11A and 11B, the \tilde{m} criteria applied to both sides of the deadband is the more general and symmetric approach. However, this criteria also changes the upper limit at which a unit will turn ON, from 1 to 1+k\tilde{m}, which results in the houses spending more time at warmer temperatures above the deadband. Replacing θ−k\tilde{m}≥1 with the θ≥1 criterion from the standard thermostat criteria results in one-sided \tilde{m} criteria and reduces the time spent outside the deadband.

$$m ( t ) = \{ \begin{matrix}0 , & if θ - k \tilde{m} \leq 0 \\ 1 , & if θ \geq 1 \\ m ( {t}^{-} ) , & otherwise\end{matrix}$$

Here we implement the one-sided \tilde{m} criteria upon completion of the DR event. As seen in FIGS. 11A and 11B, the aggregate response is similar to that of the original two-sided criteria. References 1102, 1112 depict the one-sided \tilde{m} criteria demand profile post DR event. As shown in FIGS. 11A and 11B, the oscillations are removed and post-DR peak is prevented from rising to the synchronized levels of the baseline event.

The benefit of the one-sided criteria is that there is an initial spike during the 15-minute DR event where some houses coast above the upper deadband limit, but upon implementation of the criteria those house promptly return to their deadband. Since the one-sided criteria effectively shrinks the deadband width, the cost of implementing this criteria may be an increase in the number cycles the AC units experience.

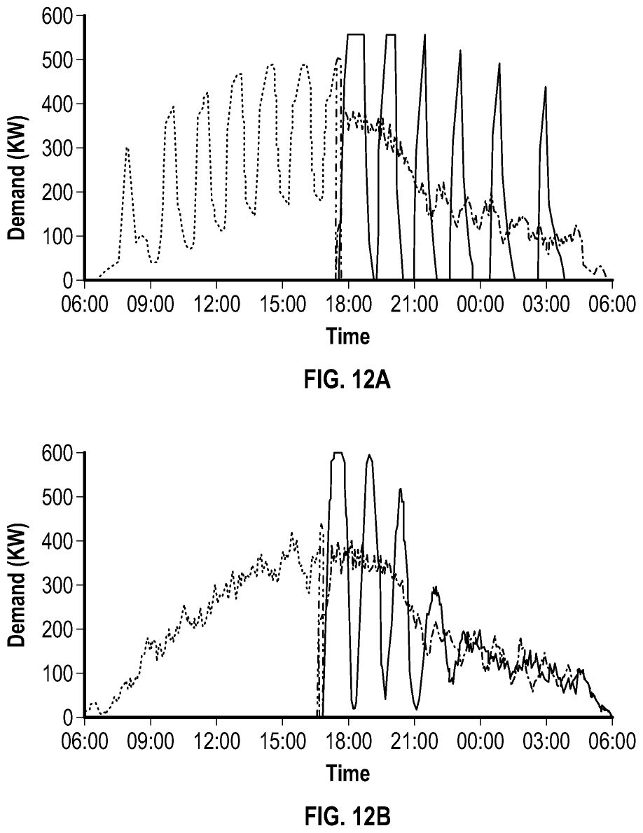

Referring to FIGS. 12A and 12B, the \tilde{m} criteria has shown an ability to respond to a DR event where houses are forced off for a set period of time. However, instead of reacting to a DR event, let the DR event be created by engaging the \tilde{m} criteria. The initial start time of the DR event remains the same, but rather than turning off all AC units, the thermostats switch from typical thermostat criteria to the one-sided m^{˜} criteria. As seen in FIGS. 12A and 12B, this switch in criteria causes many thermostats to immediately enter the off state, resulting in a drop in aggregate demand.

The homogeneous population depicted in FIG. 12A sheds approximately 80% of the load shed during a typical DR event. However, the load of the criteria created event starts increasing immediately and by the end of the 15 minute event reaches 50% of load typically shed. It takes the criteria created event 19 minutes to return to 75% of the pre-DR event load, while implementation of the criteria post-DR requires less than three minutes to reach the same level. As shown in FIG. 12B, switching the heterogeneous population to the m^{˜} criteria results in a drop in demand that isn't as pronounced as the homogeneous population's response, only shedding approximately 45% of the load shed during the typical DR event, which by the end of the 15 minute DR event has climbed to 35% of load typically shed. It takes the criteria created event 24 minutes to return to 75% of the pre-DR event load, while implementation of the criteria post-DR requires less than one minute to reach the same level.

As the simulations depicted in FIGS. 9A-12B show, substantial benefit may be achieved by implementing the systems described herein.

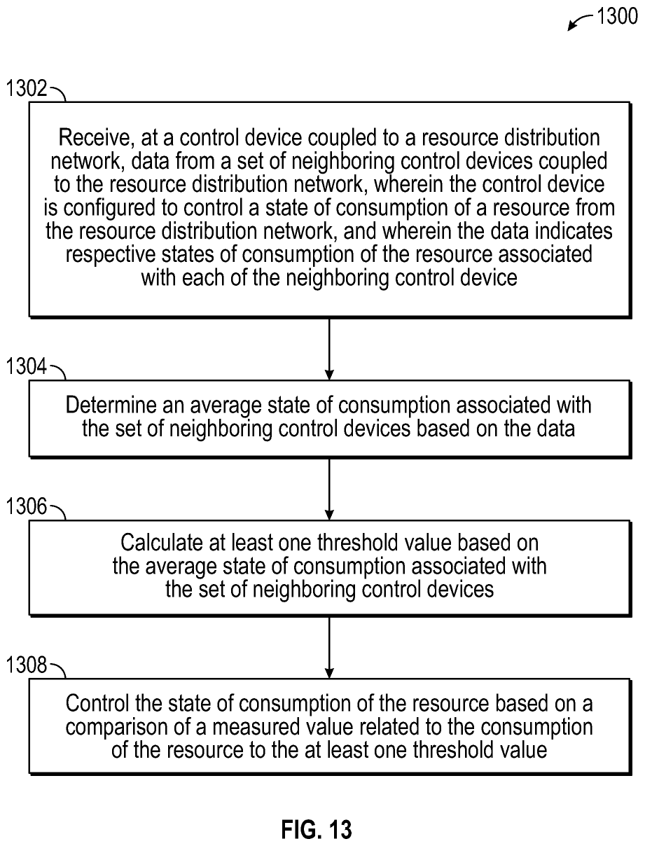

Referring to FIG. 13, an embodiment of a method 1300 for controlling resource distribution is depicted. The method 1300 may include receiving, at a control device coupled to a resource distribution network, data from a set of neighboring control devices coupled to the resource distribution network, wherein the control device is configured to control a state of consumption of a resource from the resource distribution network, and wherein the data indicates respective states of consumption of the resource associated with each of the neighboring control devices, at 1302. For example, the control device 120 may be configured to receive the data 220.

The method 1300 may further include determining an average state of consumption associated with the set of neighboring control devices based on the data, at 1304. For example, the control device 120 may be configured to determine the average state of consumption 206.

The method 1300 may also include calculating at least one threshold value based on the average state of consumption associated with the set of neighboring control devices, at 1306. For example, the control device 120 may be configured to calculate the threshold value 208.

The method 1300 may include controlling the state of consumption of the resource based on a comparison of a measured value related to the consumption of the resource to the at least one threshold value, at 1308. For example, the state of consumption 212 of the control device 120 may be controlled based on the threshold value 208 and the measured value 210.

Individual examples relating to thermostats, battery chargers, and network devices have been illustrated herein. However, as would be understood by persons of ordinary skill in the art, having the benefit of this disclosure, the systems and methods described herein may be applied to networks including combinations of thermostats, battery chargers, and network devices. For example, a single control device may determine a consumption state for controlling temperatures, electrical charges, data rates, and other resources. This disclosure is not intended to be limited to single device networks.

Although various embodiments have been shown and described, the present disclosure is not so limited and will be understood to include all such modifications and variations as would be apparent to one skilled in the art.

What is claimed is:

1. A method comprising:
receiving, at a control device coupled to a resource distribution network, data from a set of neighboring control devices coupled to the resource distribution network, wherein the control device is configured to control a state of consumption of a resource from the resource distribution network, and wherein the data indicates respective states of consumption of the resource associated with each of the neighboring control devices;
determining an average state of consumption associated with the set of neighboring control devices based on the data;
calculating at least one threshold value based on the average state of consumption associated with the set of neighboring control devices; and
controlling the state of consumption of the resource based on a comparison of a measured value related to the consumption of the resource to the at least one threshold value.

2. The method of claim 1, wherein the control device includes a thermostat, wherein the resource distribution network includes an electrical power distribution network, wherein the set of neighboring control devices includes a set of neighboring thermostats, wherein the state of consumption includes an on-off-state of the thermostat, wherein the resource includes electrical power, wherein the measured value includes a measured temperature value, and wherein the respective states of consumption include respective on-off-states of associated with the set of neighboring thermostats.

3. The method of claim 2, wherein the average state of consumption includes a ratio of neighboring thermostats in an on-state to a total number of thermostats in the set of neighboring thermostats.

4. The method of claim 2, wherein calculating the at least one threshold value includes calculating a temperature deadband relative to a predetermined reference temperature deadband.

5. The method of claim 4, wherein calculating the temperature deadband includes calculating a lower temperature limit of the temperature deadband by shifting a lower temperature limit of the predetermined reference temperature deadband based on the average state of consumption.

6. The method of claim 4, wherein calculating the temperature deadband includes calculating a lower temperature limit and an upper temperature limit of the temperature deadband by shifting a lower temperature limit and an upper temperature limit of the predetermined reference temperature deadband based on the average state of consumption.

7. The method of claim 1, wherein the control device includes a battery charger, wherein the resource distribution network includes an electrical power distribution network, wherein the set of neighboring control devices includes a set of neighboring battery chargers, wherein the resource includes electrical power, and wherein the measured value includes a measured battery charge.

8. The method of claim 7, wherein the state of consumption includes an on-off-state of the battery charger, and wherein the respective states of consumption include respective on-off-states of associated with the set of neighboring battery chargers.

9. The method of claim 7, wherein the state of consumption includes an electrical power consumption level of the battery charger, and wherein the respective states of consumption include respective electrical power consumption levels associated with the set of neighboring battery chargers.

10. The method of claim 1, wherein the control device includes a data network endpoint device, wherein the resource distribution network includes a data network, wherein the set of neighboring control devices includes a set of neighboring data network endpoint devices, wherein the state of consumption includes a data transfer rate of the data network endpoint device, wherein the resource includes network data, wherein the measured value includes a measured data transfer value, and wherein the respective states of consumption include respective data transfer rates associated with the set of neighboring data network endpoint devices.

11. The method of claim 1, wherein the data is received directly from the set of neighboring control devices using a peer-to-peer communication protocol.

12. The method of claim 1, wherein the data is received from the set of neighboring control devices via a central server.

13. The method of claim 1, further comprising:
before controlling the state of consumption of the resource based on a comparison of the measured value to the at least one threshold value, receiving a demand response instruction; and
controlling the state of consumption based on the demand response instruction.

14. A system comprising:
a resource distribution network;
multiple control devices coupled to the resource distribution network, wherein each of the control devices is configured to:
control a state of consumption of a resource from the resource distribution network;
receive data from a set of neighboring control devices, wherein the data indicates respective states of consumption of the resource associated with each of the neighboring control devices;
determine an average state of consumption associated with the set of neighboring control devices based on the data; and
calculate at least one threshold value based on the average state of consumption associated with the set of neighboring control devices, wherein controlling the state of consumption of the resource is based on a comparison of a measured value to the at least one threshold value.

15. The system of claim 14, wherein the multiple control devices include thermostats, wherein the resource distribution network includes an electrical power distribution network, wherein the state of consumption includes an on-off-state, wherein the resource includes electrical power, wherein the measured value includes a measured temperature value, and wherein the respective states of consumption include respective on-off-states of associated with the set of neighboring control devices.

16. The system of claim 14, wherein the multiple control devices include thermostats, wherein the resource distribution network includes an electrical power distribution network, wherein the state of consumption includes a transitional state between on-off-states, wherein the resource includes electrical power, wherein the measured value includes a measured temperature value, and wherein the respective states of consumption include respective on-off-states of associated with the set of neighboring control devices.

17. The system of claim 14, wherein the multiple control devices include battery chargers, wherein the resource distribution network includes an electrical power distribution network, wherein the set of neighboring control devices includes a set of neighboring battery chargers, wherein the resource includes electrical power, and wherein the measured value includes a measured battery charge.

18. The system of claim 14, wherein the multiple control devices include data network endpoint devices, wherein the resource distribution network includes a data network, wherein the set of neighboring control devices includes a set of neighboring data network endpoint devices, wherein the state of consumption includes a data transmission bandwidth consumption of the data network endpoint device, wherein the resource includes data transmission, wherein the measured value includes a measured data upload-download value, and wherein the respective states of consumption include respective data transmission bandwidth consumption associated with the set of neighboring data network endpoint devices.

19. The system of claim 14, wherein the multiple control devices communicate using peer-to-peer protocols.

20. A control device comprising:
a processor and memory storing instructions that, when executed by the processor, cause the control device to:
control a state of consumption of a resource from a resource distribution network;
receive data from a set of neighboring control devices, wherein the data indicates respective states of consumption of the resource associated with each of the neighboring control devices;
determine an average state of consumption associated with the set of neighboring control devices based on the data; and
calculate at least one threshold value based on the average state of consumption associated with the set of neighboring control devices, wherein controlling the state of consumption of the resource is based on a comparison of a measured value to the at least one threshold value.

21. The device of claim 20, wherein the control device includes a thermostat, wherein the resource distribution network includes an electrical power distribution network, wherein the set of neighboring control devices includes a set of neighboring thermostats, wherein the state of consumption includes an on-off-state of the thermostat, wherein the resource includes electrical power, wherein the measured value includes a measured temperature value, and wherein the respective states of consumption include respective on-off-states of associated with the set of neighboring thermostats.

22. The device of claim 21, wherein the average state of consumption includes a ratio of neighboring thermostats in an on-state to a total number of thermostats in the set of neighboring thermostats.
